(19) United States
(12) Patent Application Publication
(10) Pub. No.: US 2025/0306984 A1
(43) Pub. Date: Oct. 2, 2025

(54) INFORMATION PROCESSING APPARATUS, DEVICE MANAGEMENT METHOD, AND NON-TRANSITORY COMPUTER-READABLE STORAGE MEDIUM CONTAINING COMPUTER-EXECUTABLE INSTRUCTIONS FOR SUCH A METHOD

(71) Applicant: BROTHER KOGYO KABUSHIKI KAISHA, Nagoya (JP)

(72) Inventor: Eriko TAKAHASHI, Nagoya (JP)

(21) Appl. No.: 19/089,553

(22) Filed: Mar. 25, 2025

(30) Foreign Application Priority Data
Mar. 29, 2024 (JP) 2024-056743

(51) Int. Cl. G06F 9/48

(52) U.S. Cl. CPC G06F 9/485; G06F 9/4831; G06F 2209/484

(57) ABSTRACT

An information processing apparatus is configured to sequentially issue an execution instruction of a task to a target device associated with the task for each of one or more tasks, obtain an execution status of the task corresponding to the execution instruction in the one or more tasks, and exclude a specific state device, which is a device in a specific state that cannot complete the task corresponding to the execution instruction, from at least one task associated with the specific state device of the one or more tasks based on the obtained execution status in a case where the specific state device exists in the multiple devices.

### REFERENCE TO RELATED APPLICATIONS

This application claims priority from Japanese Patent Application No. 2024-056743 filed on Mar. 29, 2024. The entire content of the priority application is incorporated herein by reference.

### BACKGROUND ART

The present disclosure relates to technique to cause multiple devices to execute tasks, respectively.

A technology has been known in which an image processing device receives a firmware update instruction from a management server and then updates the firmware implemented therein. In this technology, the image processing device makes a request to the management server to obtain the firmware from the management server, and then updates the firmware.

### SUMMARY

In a case where the management server is configured to manage tasks of multiple devices (e.g. firmware updates), it is desirable to manage multiple devices efficiently.

Aspects of the present disclosure provide a non-transitory computer-readable storage medium containing computer-executable instructions that are executable by a controller of an information processing apparatus. The information processing apparatus is communicable with multiple devices. The computer-executable instructions is configured to, when executed by the controller, cause the information processing apparatus to perform a first execution instruction process of executing a process subject to a command group including one or more tasks, at least one of the multiple devices being associated with each of the one or more tasks as a target device that the each of the one or more tasks is to be executed, the first execution instruction process sequentially issuing an execution instruction of a task to the target device associated with the task in accordance with an particular task order for each of one or more tasks, an obtaining process of obtaining an execution status of the command group in the multiple devices for the first execution instruction process, a device exclusion process of excluding a specific state device from an excluded task group based on the obtained execution status in a case where the specific state device exists in the multiple devices, the specific state device being a device in a specific state that cannot complete the command group, the excluded task group including at least one task associated with the specific state device of the one or more tasks.

Aspects of the present disclosure provide an information processing apparatus communicable with multiple devices, the information processing apparatus comprising a controller. The controller is configured to perform an execution instruction process of executing a process subject to a command group including one or more tasks, at least one of the multiple devices being associated with each of the one or more tasks as a target device that the each of the one or more tasks is to be executed, the execution instruction process sequentially issuing execution instruction of a task to the target device associated with the task in accordance with an particular task order for each of one or more tasks, an obtaining process of obtaining an execution status of the command group in the multiple devices for the execution instruction process, and a device exclusion process of excluding a specific state device from an excluded task group based on the obtained execution status in a case where the specific state device exists in the multiple devices, the specific state device being a device in a specific state that cannot complete the command group, the excluded task group including at least one task associated with the specific state device of the one or more tasks.

Aspects of the present disclosure provide a device management method comprising sequentially issuing an execution instruction of a task to a target device associated with the task for each of one or more tasks, obtaining an execution status of the task corresponding to the execution instruction in the one or more tasks, and excluding a specific state device from at least one task associated with the specific state device of the one or more tasks based on the obtained execution status in a case where the specific state device exists in the multiple devices, the specific state device being a device in a specific state that cannot complete the task corresponding to the execution instruction.

### BRIEF DESCRIPTION OF DRAWINGS

FIG. 1 is a block diagram of a device management system according to the present embodiment.

FIG. 2 illustrates a main list in its initial sate, before a task management process is started.

FIG. 3 is a diagram illustrating a main list, a task-deferred device list, and a task-rejected device list in a first scene after a task management process is started.

FIG. 4 is a diagram illustrating the main list in a second scene, which comes after the first scene, after the task management process is started.

FIG. 5 is a modification of the main list in the second scene.

FIG. 6 is a flowchart illustrating a task management process.

FIGS. 7A and 7B are a flowchart illustrating an execution status reflection process.

FIG. 8 is a flowchart illustrating a task-deferment release process.

FIG. 9 is a flowchart illustrating a task-rejection release process.

### DESCRIPTION

Hereinafter, an embodiment according to aspects of the present disclosure will be described.

### Embodiment

### Overview of Management System

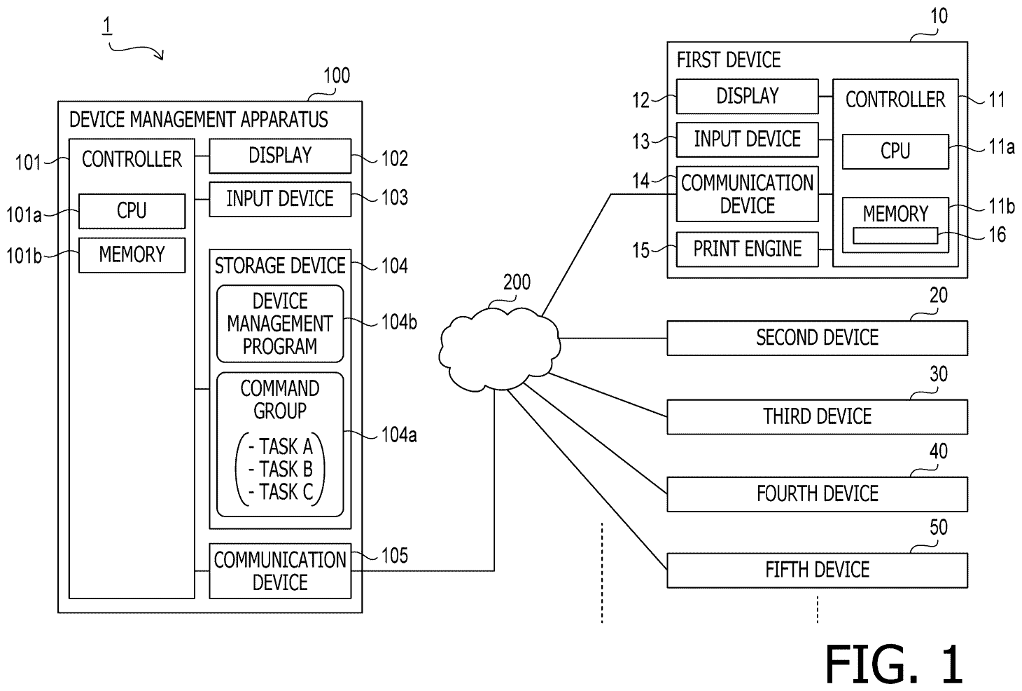

A device management system 1 of the present embodiment, as shown in FIG. 1, includes a device management apparatus 100 and multiple devices. The multiple devices include a first device 10, a second device 20, a third device 30, a fourth device 40, and a fifth device 50.

Each of the multiple devices may be in any form. Each of the multiple devices may be, for example, in the form of an electronic device that is equipped with a computer and configured to perform various processes in accordance with a program (e.g., firmware).

Concretely, each of the plurality of devices may be in a form of a peripheral device. Specifically, each of the multiple devices may be, for example, in a form of an image forming device or an image reading device. The image forming device forms (i.e., prints) an image on a printing medium. The image reading device reads an image of a document and generates data representing the read image. In the present embodiment, for the sake of simplicity, the following description will continue assuming that all of the multiple devices are in the form of image forming devices.

The device management apparatus 100 is configured to communicate with each of the multiple devices via the network 200. The network 200 may be of any type. The network 200 may include a WAN and/or a LAN. The network 200 may include a wireless communication network. The device management apparatus 100 and the multiple devices may be wired or wirelessly connected to the network 200.

The device management apparatus 100 is configured to manage multiple devices via the network 200. The management by the device management apparatus 100 includes causing each device to perform arbitrary tasks. The device management apparatus 100 according to the present embodiment is configured to cause each of the multiple devices to perform one of more tasks. The task is provided in the form of computer programs and/or commands. The tasks according to the present embodiment include updating of firmware 16 implemented in each of the multiple devices.

### Configuration of Management Apparatus

The device management apparatus 100 includes a controller 101, a display 102, an input device 103, a storage device 104, and a communication device 105. The above components of the device management apparatus 100 may be accommodated in one physical casing or in multiple physical casings in a distributed manner.

The display 102 is configured to display various pieces of information so as to be visually recognizable. The display 102 is provided with an LCD or a similar display device. The input device 103 is configured to receive various types of input operations by users (hereinafter, referred to as an administrator) of the device management apparatus 100. The input device 103 includes, for example, a keyboard, a mouse, and similar input interfaces.

The controller 101 includes a computer provided with a CPU 101a and a memory 101b. The CPU 101a is configured to perform various processes in accordance with program(s) loaded to the memory 101b. The memory 101b may include semiconductor memories such as a ROM, a RAM, an NVRAM, a flash memory, and/or similar devices.

The storage device 104 has a configuration as an example of a non-transitory computer-readable storage medium. The storage device 104 is configured store programs to be executed by the CPU 101a, and various data to be used when, for example, the various programs are executed by the CPU 101a. The storage device 104 may include an HDD (hard disk drive), an SSD (solid state drive), and/or similar storage devices.

In the present embodiment, the storage device 104 stores a device management program 104b. The storage device 104 further stores an operations system (not shown). The device management program 104b and the operating system have been installed in the device management apparatus 100.

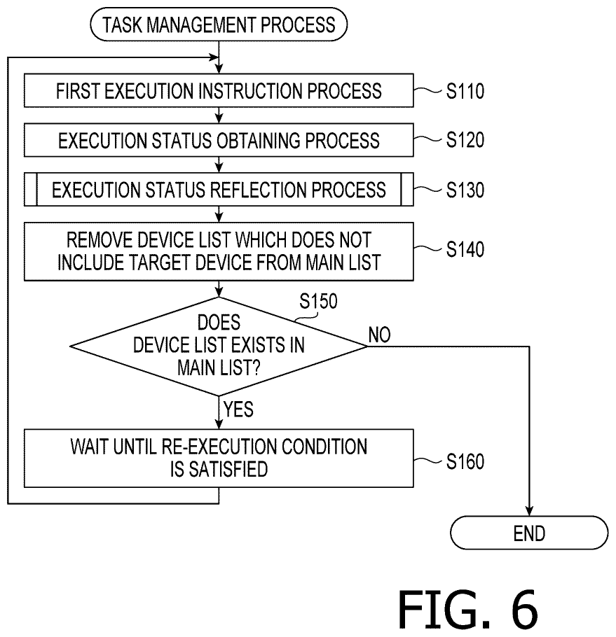

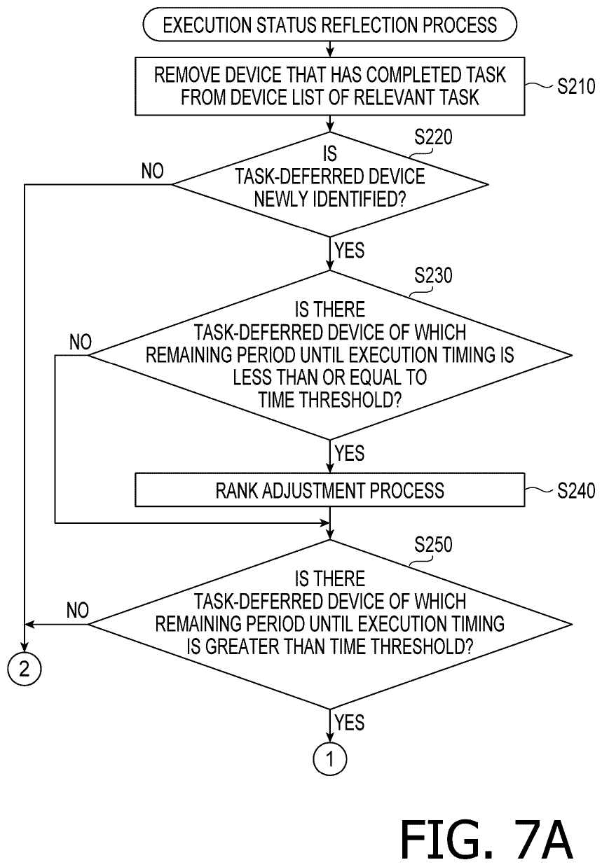

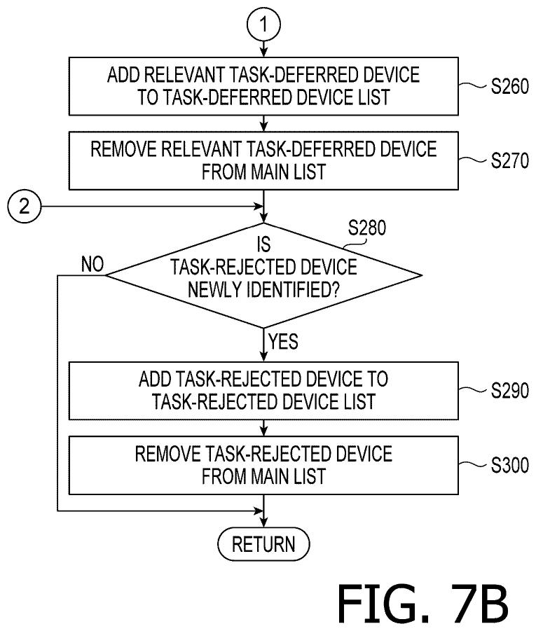

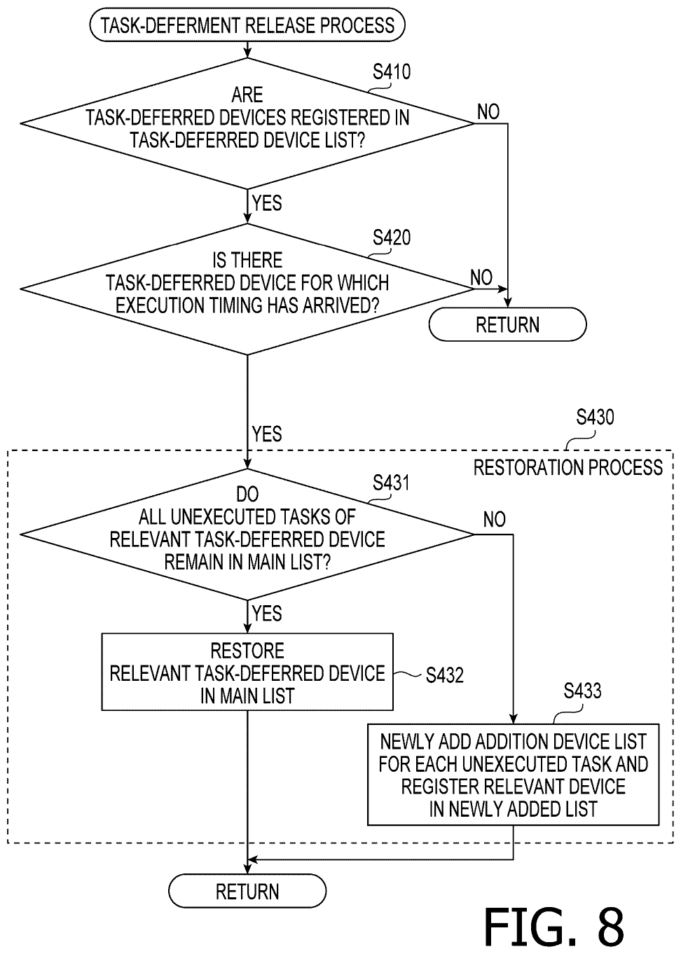

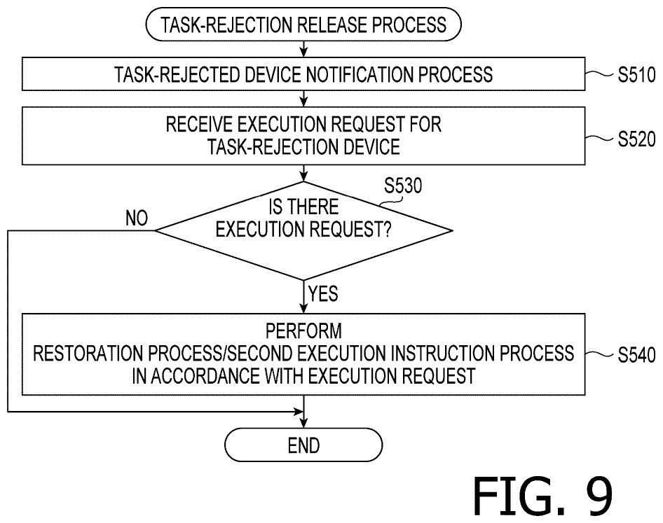

The management of the multiple devices by the device management apparatus 100 is realized as the controller 101 executes the device management program 104b. It should be noted that a task management process (see FIG. 6), an execution status reflection process (see FIGS. 7A and 7B), a task-deferment release process (see FIG. 8), and a task-rejection release process (see FIG. 9), which will be described in detail later, are parts of processes realized by the device management program 104b.

The storage device 104 may store a command group 104a. The command group 104a includes one or more tasks to be performed by the multiple devices. The command group 104a may by stored in the storage device 104 by, for example, a particular input operation by the administrator via the input device 103. In other words, the administrator is capable of arbitrarily setting desired task(s) to be performed by the multiple devices in the device management apparatus 100 as the command group 104a. That is, the administrator is capable of arbitrarily storing the desired task(s) to be performed by the multiple devices in the storage device 104 as the command group 104a.

In the following description on the present embodiment, a case where three tasks (i.e., a task A, a task B and a task C) are set as the tasks to be realized as the command group 104a will be described. Each of the tasks A-C is a task (i.e. a program) to update the firmware 16 of each of the multiple devices.

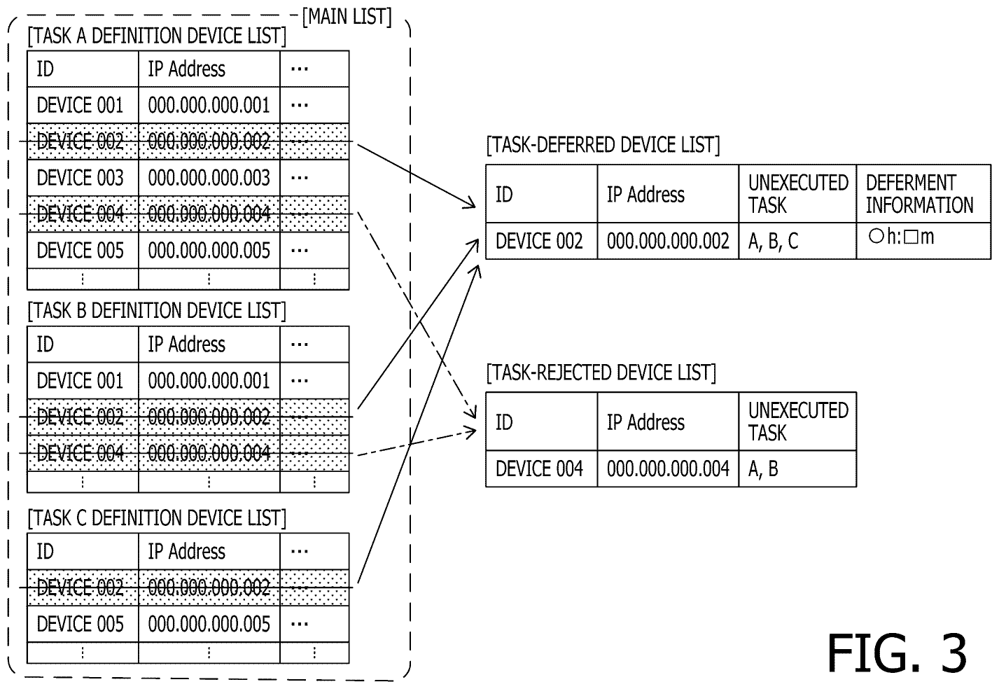

The storage device 104 or the memory 101b may store a main list (described later), a task-deferred device list (see FIG. 3) and a task-rejected device list (see FIG. 3). The main list is prepared by the administrator. The task-deferred device list and the task-rejected device list may be generated in the process according to the device management program 104b. The administrator is capable of visually recognize the contents of the main list, the task-deferred device list and the task-rejected device list via, for example the display 102.

The communication device 105 is an interface for accessing the network 200. The device management apparatus 100 (specifically, the controller 101) is configured to connect with the network via the communication device 105 and communicate with multiple devices connected to the network 200.

The administrator may access the device management apparatus 100 via an information processing apparatus that is different from the device management apparatus 100 and is capable of communicating with the device management apparatus 100. That is, the administrator may be able to set the command group 104a along with the main list to the information processing apparatus. The information processing apparatus may be configured to transmit the set command group 104 and the main list to the device management apparatus 100. The device management apparatus 100 may be configured to store the transmitted command group 104a and the main list in the storage device 104. The administrator may instruct the device management apparatus 100, from the information processing apparatus, to execute the device management program 104b. The administrator may be able to monitor status of the main list, the task-deferred device list and/or the task-rejected device list.

### Configuration of Devices

The first device 10 configured to have the form of the image forming device as described above, and have at least a printing function. As shown in FIG. 1, the first device 10 includes a controller 11, a display 12, an input device 13, a communication device 14, and a print engine 15.

The display 12 is configured to display various information so as to be visually recognized. The display 102 includes a display device such as an LCD or similar display devices. The input device 13 is configured to receive various input operations by a user of the first device 10. The input device 13 may include an input interface such as a numeric keyboard, various buttons, switches, and similar operable elements.

The controller 11 includes a CPU 11a and a memory 11b. The memory 11b may include semi-conductive elements such as a ROM, a RAM, an NVRAM, a flash memory and/or similar devices. In a non-volatile memory such as the ROM or the flash memory of the memory 11b, firmware 16 and data for realizing various functions of the first device 10 are stored. The CPU 11a integrally controls the first device 10 by executing processes in accordance with the firmware 16.

The communication device 14 is a communication interface for connecting with the network 200. The first device 10 (specifically, the controller 11) is configured to connect with the network 200 and communicate with the device management apparatus 100 via the communication device 14.

The print engine 15 includes, for example, a print mechanism according to, for example, an inkjet printing method or an electrophotographic imaging method, and is configured to print images on printing media. The second to fifth devices may have a hardware configuration substantially similar to that of the first device 10.

### Main List

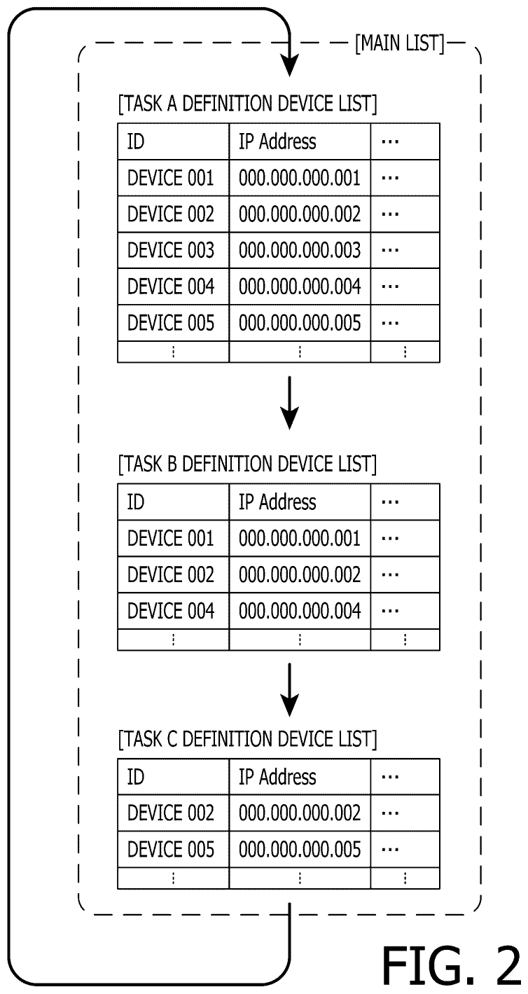

The main list shown in FIG. 2 is set by the administrator as described above. The main list is set to have each task of the command group 104a executed by a target device tasked with its execution. The execution instructions in the command group 104a, which are directed to the respective devices, are carried out in accordance with the main list. Specifically, each target device executes its respective instructed task in response to receiving the corresponding execution instruction.

The execution instructions of the tasks may be issued in any manner. For example, the execution instructions of a task may include transmission of a task execution command. The task execution command may include a program necessary to execute the task. Alternatively, the task execution command may include only a part of the program necessary to execute the task. Specifically, the task execution command may include an instruction to execute the task and related information but may not include the substantial program (e.g., an exe file for updating firmware) required to execute the task. In such a case, the target device may download the necessary program from the device management apparatus 100, another information processing apparatus, or a similar device in response to receiving the task execution instruction.

As indicated in the example shown in FIG. 2, the main list includes a definition device list for each of the tasks contained in the command group 104a. Each definition device list is associated with a target device and the device information related to that target device. The device information include, for example, ID and an IP address.

In FIG. 2, “DEVICE 001” indicates the first device 10, “DEVICE 002” indicates the second device 20, “DEVICE 003” indicates a third device 30, “DEVICE 004” indicates a fourth device 40, and “DEVICE 005” indicates a fifth device 50.

In each definition device list, an instruction order for the target devices corresponding to the list is specified. The instruction order represents a sequence in which instructions are carried out within the definition device list. The task execution instructions to the target devices are carried out sequentially according to the specified instruction order.

The main list of the present embodiment concretely has a task A definition device list, a task B definition device list, and a task C definition device list. The task A definition device list is associated with the execution target devices that should execute task A. The execution target devices for task A include, for example, the first to fifth devices 10 to 50. The task B definition device list is associated with the execution target devices that should execute task B. The target devices for task B include, for example, the first, second and fourth devices 10, 20 and 40. The definition device list for task C includes the target devices for task C. The target devices for task C include, for example, the second and fifth devices 20 and 50.

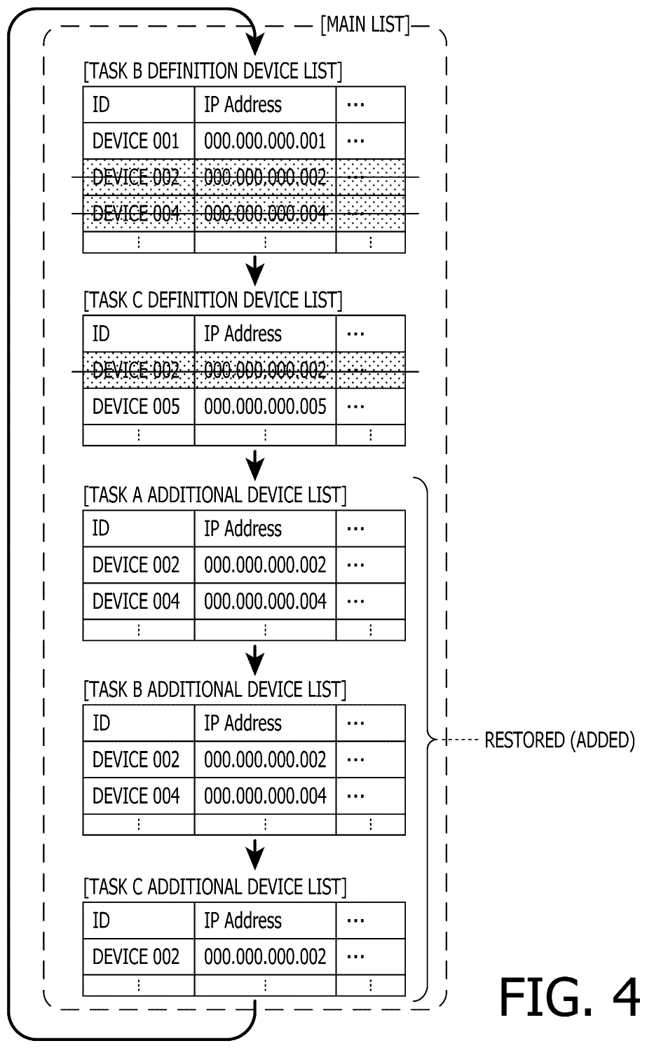

In the task A definition device list, the target devices are listed in ascending order according to the instruction order (i.e., from the highest-priority device). Specifically, the first device 10 is ranked first in the instruction order, and the fifth device 50 is ranked fifth. The same applies to the task B definition device list and the task C definition device list, as well as to the addition device list (see FIG. 4) described below. The instruction order may be determined in any manner, including randomly.

In the present embodiment, when simply referring to a “definition device list,” this refers to the task A definition device list, the task B definition device list, and/or the task C definition device list. When simply referring to an “addition device list,” it refers to the task A addition device list, task B addition device list and/or task C addition device list shown in FIG. 4. When simply referring to a “device list,” it refers to at least one of all the definition device lists and/or addition device lists included in the main list.

In the main list, a task order is determined. The task order specifies the sequence in which execution instructions for tasks are input to the target device. In the present embodiment, the task order is defined such that task A is first, task B is second, and task C is third. Task execution instructions are sequentially carried out in accordance with the task order.

Initially, the execution instruction for task A is issued. Specifically, the controller 101 sequentially issues the execution instructions for task A to the target devices in the order specified in the task A definition device list. Next, the execution instruction for task B is issued. Specifically, in accordance with the instruction order specified in the task B definition device list, the controller 101 sequentially issues the execution instructions to the target devices. Finally, the execution instruction for task C is issued. Specifically, in accordance with the instruction order specified in the task C definition device list, the controller 101 sequentially issues the execution instructions to the target devices. A series of execution instructions of the tasks A-C in accordance with the main list will be referred to a first execution instruction process (see S120 of FIG. 6). The first execution instruction process will be performed repeatedly as will be described later. It should be noted that the order of the tasks may be determined in any manner. Further, the order of the tasks may be randomly determined. The order of the tasks and the order of the instructions mentioned above can be set by the administrator as desired.

When receiving the execution instruction, each device executes the instructed task automatically or in response to a user's operation. It should be noted that, according to the present embodiment, it is allowed to defer or reject the execution of the instructed task according to the execution instruction in each device.

Each device may be configured to issue a notification indicating receipt of an execution instruction in response to receipt of the execution instruction of the task from the device management apparatus 100. The notification may be issued in any manner. The notification may include, for example, displaying of particular messages on the display 12.

Further, the task may be executed if the user performs no operation in response to the notification or performs a particular first input operation indicating acceptance of the execution instruction. On the other hand, the user may be allowed to instruct the deferment or rejection of the task execution in response to the notification.

The user can instruct the deferment of task execution by performing a specific second input operation via the input device 13. When the deferment of task execution is instructed, the device updates its status to “deferred.” Alternatively or additionally, the device may notify the device management apparatus 100 that it has been set to the “deferred state” (i.e., indicating the user's intent to defer) along with attribute information. The attribute information includes details of the task for which deferment is instructed and deferment information specifying a deferred period.

The deferment information may include any information. For example, the deferment information may include information that indicates, directly or indirectly, an expiration period of the deferred period, that is, an execution timing when the task in question is to be executed. The execution timing may be, for example, the date and/or time when the deferred period expires. In the following description, the term “task-deferred device” refers to a device that has been set to a “deferred state,” i.e., a device for which the task has been instructed to be deferred.

When the deferred period has expired, the device removes the “deferred state” of the task in question. The task-deferred device may execute the instructed task in accordance with the previously received execution instruction after the deferred period has elapsed. Alternatively, the device may continue to suspend the execution of the task until the execution instruction is received again, even after the deferred period has elapsed.

Regarding rejection, the user can instruct the rejection of task execution by performing a particular third input operation via the input device 13. When the rejection of task execution is instructed, the device updates its status to set the task in question to the “rejected state.” Alternatively or additionally, the device may notify the device management apparatus 100 that the task in question has been set to the “rejected state” (i.e., indicating the user's intent to reject the task), along with information identifying the task in question.

The user of the device can instruct the deferment or rejection of tasks individually. Alternatively, using the command group 104a, the user may collectively instruct the deferment or rejection of all tasks associated with the device.

The device management apparatus 100 obtains the execution status of each task in the main list from the target device after the first execution instruction process. The execution status includes, for example, “completed,” “incomplete,” “deferred,” “rejected,” and “inexecutable.”

In the execution status, “completed” means that the instructed task has been completed. “Incomplete” means that while the device is functioning normally and the execution instruction has been received successfully, the instructed task has not yet been completed. “Deferred” indicates that the device is set to the “deferred state.” “Rejected” indicates that the device is set to the “rejected state.” “Inexecutable” refers to cases where the task cannot be executed and/or the execution instruction cannot be received, due to factors such as a malfunction of the device, abnormal communication status, lack of connection, or the device being powered off.

The device management apparatus 100 removes the target devices with an execution status of “completed” from the relevant device list. In this embodiment, as described later, target devices with an execution status of “deferred” (i.e., task-deferred devices) and target devices with an execution status of “rejected” (i.e., task-rejected devices) are also removed from the relevant device list.

It should be noted that the task-deferred devices are added to the task-deferred device list, and the task-rejected devices are added to the task-rejected device list (see FIG. 3). The task-deferred device list and the task-rejected device list are different list from the main list.

In the present embodiment, a series of first execution instruction processes based on the main list is repeatedly performed until all target devices are removed from the main list. The first execution instruction processes may be repeatedly performed at specified time intervals. Alternatively, the first execution instruction process may be performed again when a specific re-execution condition is satisfied after the previous execution.

Even if all target devices are removed from the main list, task-deferred devices may still remain in the task-deferred device list, and task-rejected devices may still remain in the task-rejected device list.

The process of the device management apparatus 100 when the deferment or rejection is instructed by the target device will be described with reference to FIG. 3.

FIG. 3 shows an example in which at least the deferment of task A is instructed in the second device 20 and at least the rejection of task A is instructed in the fourth device 40. That is, FIG. 3 shows a case where the second device 20 is the task-deferred device and the fourth device 40 is the task-rejection device.

In this case, the second device 20 and the fourth device 40 are removed from the main list. Specifically, the second device 20 is removed from all device lists in the main list to which the second device 20 is associated (in FIG. 3, the task A definition device list, the task B definition device list, and the task C definition device list).

Then, the removed second device 20 is added to the task-deferred device list. Specifically, the device information, unexecuted task information and deferment information of the second device 20 are registered with the task-deferred device list. The unexecuted task information indicates the task in the main list from which the device was removed in its definition device list. In other words, the unexecuted task information specifies the task that was set to be executed in the main list. Further, it indicates which of the tasks to be executed has not yet been executed.

The fourth device 40 is removed from all device lists in the main list to which the fourth device 40 is associated (in FIG. 3, the task A definition device list and the task B definition device list). The excluded fourth device 40 is then added to the task-rejected device list separately. Specifically, the device information of the fourth device 40 and the unexecuted task information are registered.

In the present embodiment, if deferment is instructed for at least one of the tasks assigned to a target device, the target device (i.e., the task-deferred device) is removed from all device lists in the main list to which the task-deferred device is associated. The same applies if rejection is instructed.

However, it is not mandatory to remove all task-deferred devices from the main list. For example, when deferment can be instructed on a per-task basis, the target device may be removed only from the tasks for which deferment has been instructed. In such cases, only the tasks for which deferment has been instructed may be registered as unexecuted tasks for the target device in the task-deferred device list.

Additionally, the task-deferred device may be removed only from the device list of the first task among the multiple tasks remaining in the main list for the task-deferred device. More specifically, if completing the first task is not required for executing the second (or subsequent) task among the multiple tasks remaining for the task-deferred device, the task-deferred device may remain in the device lists of the second (or subsequent) task. These are merely examples, and it may be appropriately determined from which device list among the multiple device lists the task-deferred device is to be removed.

The same applies when removing a task-rejected device from the main list. That is, it may be appropriately determined, as in the above examples for task-deferred devices, from which device list among the multiple device lists containing the task-rejected device it should be removed.

In the present embodiment, when deferment is instructed, a task-deferred device may be retained in the main list instead of being added to the task-deferred device list. Specifically, if the remaining time until the specified execution timing (i.e., the end of the deferment period) is less than or equal to a time threshold, the task-deferred device is retained in the main list without being added to the task-deferred device list. In this case, however, the instruction order of the task-deferred device in the main list is lowered from its current rank. On the other hand, if the remaining time exceeds the time threshold, the task-deferred device is added to the task-deferred device list and removed from the main list in the manner described above.

A task-deferred device for which the execution timing has arrived is restored to the main list from the task-deferred device list. At this time, if the original definition device list to which it was previously assigned still remains, the device is restored to that list. Here, “still remains” means that target devices are still present in the list.

For example, in FIG. 3, when the execution timing for the second device 20 in the task-deferred device list arrives, and the definition device lists for tasks A to C still remain in the main list, the second device 20 is restored to those definition device lists. At this time, the second device 20 may be restored to any position (any instruction order) within the definition device lists.

On the other hand, if there are tasks for which the original definition device list no longer remains, an addition device list for at least those tasks is newly generated. The task-deferred device is then registered in the addition device list along with its device information.

If even one of the unexecuted tasks does not have a remaining definition device list, addition device lists may be generated for all unexecuted tasks. This is referred to as the first pattern.

On the other hand, it is possible for some of the unexecuted tasks to have a remaining definition device list while others do not. In this case, the task-deferred device may be restored to the definition device lists for tasks that still have remaining definition device lists. Additionally, addition device lists may be generated only for the tasks without remaining definition device lists. This is referred to as the second pattern.

FIG. 4 illustrates an example of the first pattern. FIG. 4 shows a case where the execution timing for the second device 20 has arrived while the task A definition device list no longer remains. In this example, at the time the execution timing arrives, the definition device lists for tasks B and C remain, but the definition device list for task A does not remain. Consequently, addition device lists are newly generated for all unexecuted tasks A to C of the second device 20, and the second device 20 is registered (i.e., restored) in those lists. Specifically, a task A addition device list for executing task A, a task B addition device list for executing task B, and a task C addition device list for executing task C are newly generated. The second device 20 is then registered in each of these addition device lists.

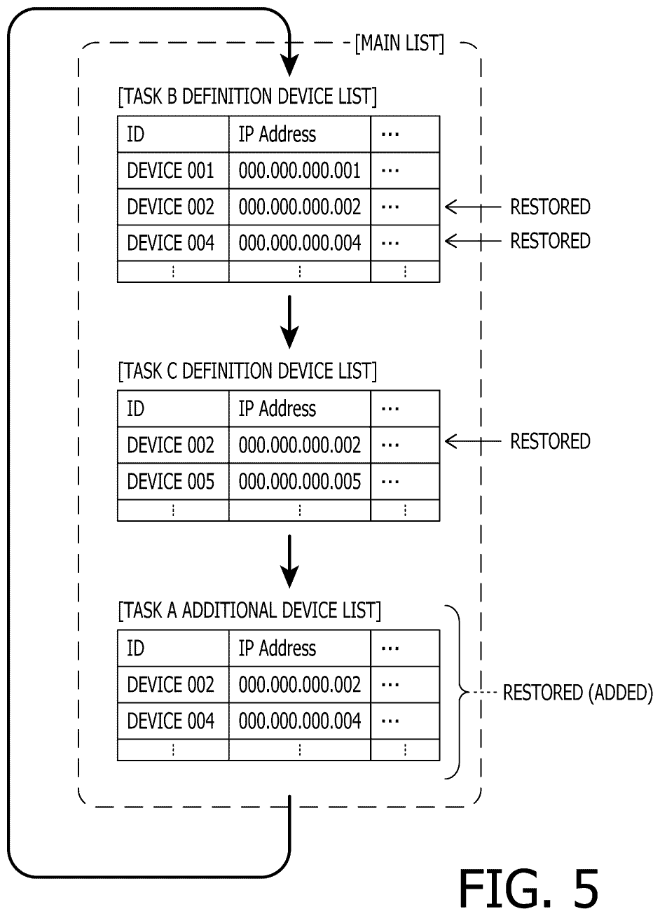

FIG. 5 illustrates an example of the second pattern. FIG. 5 shows a case where the execution timing for the second device 20 has arrived while the task A definition device list no longer remains. In this example, at the time the execution timing arrives, the definition device list for the task A does not remain, whereas the definition device lists for the tasks B and C do. For tasks B and C, the second device 20 is restored to the existing definition device lists. On the other hand, for the task A, a task A addition device list is newly generated, and the second device 20 is registered (i.e., restored) in that list.

With respect to task-rejected devices, the device management apparatus 100 notifies the administrator when a task-rejected device is registered in the task-rejected device list. This notification may be carried out in any manner. For example, the notification may be performed by displaying a message indicating the rejection on the display 12.

The administrator can recognize the presence of a task-rejected device through this notification or by performing the administrator's own confirmation operation. The administrator can restore the task-rejected device to the main list through a restoration operation via the input device 103.

In FIG. 3, when the execution timing for the fourth device 40 in the task-rejected device list arrives, and the definition device lists for the tasks A and B remain in the main list, the administrator can restore the fourth device 40 to those definition device lists by performing a restoration operation. At this time, the fourth device 40 can be restored to any position within the definition device lists.

On the other hand, when restoring a task-rejected device to the main list, either the first pattern or the second pattern described above may be applied.

FIG. 4 illustrates an example where a task-rejected device is restored in accordance with the first pattern. In FIG. 4, although the definition device list for the task B remains, the definition device list for the task A does not. Consequently, addition device lists are newly generated for all the unexecuted tasks A and B of the fourth device 40, and the fourth device 40 is registered (i.e., restored) in those lists.

If an addition device list already exists, the fourth device 40 is added to that list. However, a new addition device list may also be generated specifically for the fourth device 40. The same applies when restoring a deferred device to an addition device list.

FIG. 5 illustrates an example where a task-rejected device is restored in accordance with the second pattern. In FIG. 5, since the definition device list for the task A no longer exists, the fourth device 40 is restored to the task A addition device list. On the other hand, since the task B definition device list remains, the fourth device 40 is restored to the task B definition device list.

### Task Management Process

The task management process executed by the controller 101 of the device management apparatus 100 to implement the various functions described above in accordance with the main list will be explained with reference to FIG. 6. When the controller 101 (specifically, the CPU 101a) receives a request to execute the task management process, it begins the task management process. The execution request can be made, for example, by the administrator via the input device 103.

When starting the task management process, the controller 101 performs the first execution instruction process at S110. As already explained in detail, the first execution instruction process is a process of issuing execution instructions for tasks to the corresponding execution target devices for each device list (i.e., each task) contained in the main list.

After completing the first execution instruction process, the controller 101 performs the execution status obtaining process in step S120. Specifically, the controller 101 obtains the execution status of the instructed tasks for each target device that received an execution instruction in S110. The obtained execution statuses may include, for example, “completed,” “incomplete,” “deferred,” “rejected,” or “inexecutable,” as described earlier. The method of obtaining the execution status is not limited. For example, the controller 101 may communicate directly with the devices to obtain the status. Alternatively, the devices may be configured to transmit information indicating their execution status, which the controller 101 then uses to obtain the status.

In S130, the controller 101 performs the execution status reflection process. The execution status reflection process is a process of reflecting the execution status obtained in S120 to the main list (in other words, a process of updating the main list). The execution status reflection process is illustrated in detail in FIGS. 7A and 7B.

When the controller 101 proceeds to the execution status reflection process in step S210, the controller 101 checks whether any target device has completed the instructed task and remains in the device list for the corresponding task in the main list. If a target device meeting these conditions exists, the controller 101 removes the target device from the device list.

In S220, the controller 101 determines whether a task-deferred device has been newly identified (e.g., a device has been newly added to the task-deferred device list). If no task-deferred device has been newly identified, the process proceeds to S280. If a task-deferred device has been newly identified, the process proceeds to S230.

In S230, the controller 101 determines whether there are any task-deferred devices among the newly identified devices whose remaining time before the intended execution timing within the deferred period is less than or equal to a time threshold. If there are no task-deferred devices with a remaining time less than or equal to the time threshold, the process proceeds to S250. If there are task-deferred devices with a remaining time less than or equal to the time threshold, the process proceeds to S240.

In S240, the controller 101 performs a rank adjustment process. Specifically, the controller 101 lowers the rank of a task-deferred device with a remaining time less than or equal to the time threshold in the device list associated with the main list. In other words, for task-deferred devices with a remaining time less than or equal to the time threshold, the devices are not registered in the task-deferred device list but are instead assigned a lower rank within the device list. The degree to which the rank is lowered may be determined as appropriate. For example, the rank may be lowered to the lowest position in the device list.

In S250, the controller 101 determines whether there are any task-deferred devices among the newly identified ones with a remaining time greater than the time threshold. If no task-deferred device has a remaining time greater than the time threshold, the process proceeds to S280. If there is a task-deferred device with a remaining time greater than the time threshold, the process proceeds to S260.

In S260, the controller 101 registers the relevant task-deferred device in the task-deferred device list. Specifically, as described earlier, the controller 101 registers the device information of the relevant task-deferred device, the unexecuted task information, and the deferment information in the task-deferred device list (see FIG. 3).

In S270, the controller 101 removes the relevant task-deferred device from the main list. In S270, all instances of the task-deferred device included in the main list may be removed. In such a case, in S260, all tasks associated with the device in the main list may be registered as unexecuted task information in the task-deferred device list.

Alternatively, in S270, only a part of the task-deferred device instances included in the main list may be removed. Specifically, for example, the task-deferred device may be removed only from the device list corresponding to the first task in the task order among the device lists containing the task-deferred device. In such a case, in S260, only the task corresponding to the first device list may be registered as unexecuted task information in the task-deferred device list.

In S280, the controller 101 determines whether a new task-rejected device has been identified. If no new task-rejected device has been identified, this process ends, and the process proceeds to S140 (see FIG. 6). If a new task-rejected device has been identified, the process proceeds to S290.

In S290, the controller 101 registers the relevant task-rejected device in the task-rejected device list. Specifically, as described earlier, the controller 101 registers the device information of the relevant task-rejected device and the unexecuted task information in the task-rejected device list (see FIG. 3).

In S300, the controller 101 removes the relevant task-rejected device from the main list.

In S300, all instances of the task-rejected device included in the main list may be removed. In such a case, in S290, all tasks associated with the device in the main list may be registered as unexecuted task information in the task-rejected device list.

Alternatively, in S300, only a part of the task-rejected device instances included in the main list may be removed, in a manner similar to S270. In such a case, in S290, only the task corresponding to the first device list may be registered as unexecuted task information in the task-rejected device list.

Returning to FIG. 6, in S140, the controller 101 removes any device list from the main list if all target devices have been deleted from that device list. In S150, the controller 101 determines whether any device lists remain in the main list. If no device lists remain in the main list, the process terminates. If even one device list remains, the process proceeds to S160. In S160, the controller 101 waits until the re-execution condition is satisfied. The re-execution condition can be determined in any manner. For example, the re-execution condition may involve a certain period of time elapsing after the first execution instruction process in S110 begins, such as after the completion of S140. Once the re-execution condition is satisfied, the process proceeds to S110. If any device lists remain in the main list during S150, the process may transition directly to S110 without performing the process in S160.

### Task-Deferment Release Process

Next, the task-deferment release process will be explained with reference to FIG. 8. The task-deferment release process is a process for enabling task-deferred devices registered in the task-deferred device list to execute tasks. The controller 101 executes the task-deferment release process, for example, on a periodic basis.

When the controller 101 begins the task-deferment release process, it determines in S410 whether any task-deferred devices are registered in the task-deferred device list. If no task-deferred devices are registered in the task-deferred device list (including cases where the task-deferred device list itself does not exist), the controller 101 terminates the task-deferment release process. If task-deferred devices are registered in the task-deferred device list, the process proceeds to S420.

In S420, the controller 101 determines whether there are any task-deferred devices among the registered ones for which the execution timing has arrived. If no task-deferred devices with an execution timing that has arrived are found, the controller 101 terminates the task-deferment release process. If there are task-deferred devices with an execution timing that has arrived, the process proceeds to S430.

In S430, the controller 101 performs a restoration process. The restoration process is a process to restore task-deferred devices, for which the execution timing has arrived, to the main list. Once a task-deferred device is restored to the main list, task execution instructions for that device are issued through the first execution instruction process in S110. As shown in FIG. 8, the restoration process in S430 includes the processes in S431 to S433.

In S431, the controller 101 determines whether all unexecuted tasks associated with the task-deferred device, for which the execution timing has arrived, remain in the main list. If all unexecuted tasks remain in the main list, the process proceeds to S432. In S432, the controller 101 restores the task-deferred device to the device lists of the unexecuted tasks in the main list. If there are unexecuted tasks in S431 for which the corresponding device lists no longer remain in the main list, the process proceeds to S433. In S433, the controller 101 newly adds addition device lists for each unexecuted task to the main list. The controller 101 then registers the task-deferred device in each of the addition device lists (see FIG. 4).

The restoration process in S430 corresponds to the previously described first pattern. The restoration process in S430 may also be performed according to the previously described second pattern.

### Task-Rejection Release Process

Next, the task-rejection release process will be explained with reference to FIG. 9. The task-rejection release process is a process for enabling task-rejected devices registered in the task-rejected device list to execute tasks. When a task-rejected device is registered in the task-rejected device list, the controller 101 executes the task-rejection release process at a predetermined timing. For example, the task-rejection release process may be executed in response to determining, in S280 of FIG. 7, that a new task-rejected device has occurred.

When the controller 101 begins the task-rejection release process, it performs a task-rejected device notification process in S510. Specifically, as described earlier, the controller 101 notifies the administrator that a task-rejected device has been registered.

In S520, the controller 101 receives a task execution request for the task-rejected device. The execution request may be made, for example, through the previously described restoration operation or a direct instruction operation. The direct instruction operation is an action that instructs the task-rejected device to execute the task without restoring the task-rejected device to the main list.

In S530, the controller 101 determines whether a task execution request was made in S520. If no execution request was made, the process terminates. If an execution request was made, the process proceeds to S540.

In S540, the controller 101 performs a restoration process or a second execution instruction process, depending on the specific content of the execution request. Specifically, if the execution request was made through a restoration operation, the controller 101 performs a restoration process. The restoration process may be performed in the same manner as S430 in FIG. 8. In other words, the restoration process in S540 may be executed by substituting “task-rejected device” for “task-deferred device” in S430 of FIG. 8. Alternatively, the restoration process in S540 may be performed according to the previously described second pattern.

On the other hand, if the execution request was made through a direct instruction operation, the controller 101 performs a second execution instruction process. The second execution instruction process issues execution instructions for uncompleted tasks directly to the task-rejected device that is the subject of the execution request, without restoring the task-rejected device to the main list.

The device management apparatus 100 corresponds to an example of an information processing apparatus according to aspects of the present disclosure. The controller 101 corresponds to an example of a computer according to aspects of the present disclosure. The addition device list corresponds to an example of an additional command group according to aspects of the present disclosure. The deferred state and rejected state correspond to examples of specific states according to aspects of the present disclosure. The definition device lists (in FIG. 3, the first to third definition device lists) associated with the task-deferred device (in FIG. 3, the second device 20) and/or the task-rejected device (in FIG. 3, the fourth device 40), as illustrated in FIG. 3, correspond to examples of an excluded task group according to aspects of the present disclosure.

S120 corresponds to an example of the first execution instruction process according to aspects of the present disclosure. S130 corresponds to an example of the acquisition process according to aspects of the present disclosure. S260 and S290 each correspond to examples of the device exclusion process according to aspects of the present disclosure. S140 corresponds to an example of the task deletion process according to aspects of the present disclosure. The process in S520 corresponds to an example of a receiving process according to aspects of the present disclosure.

### Modification

While aspects of the present disclosure have been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the aspects of the present disclosure, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations according to aspects of the present disclosure are provided below.

In the above embodiment, the command group 104a included three tasks, A to C. However, the command group 104a may include two or fewer tasks or four or more tasks. Furthermore, tasks A to C in the above embodiment were tasks for updating firmware. However, the tasks to be executed by the device may involve any content.

In the task-deferment release process (FIG. 8), instead of the restoration process (S430), a second execution instruction process targeting the task-deferred device similar to the second execution instruction process in S540 of FIG. 9 may be performed. Specifically, in S430, the task-deferred device subject to the execution request may be instructed to execute uncompleted tasks without being restored to the main list.

The main list may take any form. For example, the main list may include a single list (or table). This list may register, for each target device, device information and information about the tasks to be executed. In the first execution instruction process, task execution may be sequentially instructed for each target device based on the main list.

In the above embodiment, task-deferred devices and task-rejected devices were presented as examples of specific state devices according to aspects of the present disclosure. However, the specific state devices of the present disclosure are not limited to task-deferred devices and task-rejected devices. For example, devices with an execution status of “inexecutable,” as described earlier, may also be considered specific state devices according to the present disclosure, and the techniques of the present disclosure may be applied to them. Specifically, devices with an execution status of “inexecutable” may also be excluded from the main list. Furthermore, similar to task-rejected devices, such devices may, for example, be restored to the main list at an appropriate timing through administrator operations, or task execution instructions may be issued to such devices without restoring them to the main list.

The multiple functions of a single component in the above embodiment may be implemented by multiple components, or a single function of a single component may be implemented by multiple components. Additionally, the multiple functions of multiple components may be implemented by a single component, or a single function implemented by multiple components may be implemented by a single component. Furthermore, part of the configuration of the above embodiment may be omitted.

What is claimed is:

1. A non-transitory computer-readable storage medium containing computer-executable instructions that are executable by a controller of an information processing apparatus, the information processing apparatus being communicable with multiple devices, wherein the computer-executable instructions are configured to, when executed by the controller, cause the information processing apparatus to perform:
a first execution instruction process of executing a process subject to a command group including one or more tasks, at least one of the multiple devices being associated with each of the one or more tasks as a target device that the each of the one or more tasks is to be executed, the first execution instruction process sequentially issuing an execution instruction of a task to the target device associated with the task in accordance with an particular task order for each of one or more tasks;
an obtaining process of obtaining an execution status of the command group in the multiple devices for the first execution instruction process; and
a device exclusion process of excluding a specific state device from an excluded task group based on the obtained execution status in a case where the specific state device exists in the multiple devices, the specific state device being a device in a specific state that cannot complete the command group, the excluded task group including at least one task associated with the specific state device of the one or more tasks.

2. The non-transitory computer-readable storage medium according to claim 1,
wherein the information processing apparatus repeatedly performs the first execution instruction process until all of the target devices complete tasks associated with the target devices, respectively, for each of the one or more tasks.

3. The non-transitory computer-readable storage medium according to claim 1,
wherein the excluded task group includes all uncompleted tasks of the one or more tasks, the all uncompleted tasks being tasks associated with the specific state device and which have not been completed by the specific state device.

4. The non-transitory computer-readable storage medium according to claim 1,
wherein, in a case where two or more of uncompleted tasks which have not been completed are associated with the specific state device and in a case where completion of a first task is not required for executing a second task in the particular task order among two or more of the tasks, the second task is not included in the excluded task group and the second task maintains association with the specific state device in the device exclusion process.

5. The non-transitory computer-readable storage medium according to claim 1,
wherein the computer-executable instructions are configured to, when executed by the controller, cause the information processing apparatus to perform:
a second execution instruction process of issuing an execution instruction of the task of the excluded task group to the specific state device excluded from the excluded task group by the device exclusion process.

6. The non-transitory computer-readable storage medium according to claim 1,
wherein the computer-executable instructions are configured to, when executed by the controller, cause the information processing apparatus to perform:
a restoration process of again associating the specific state device excluded from the excluded task group by the device exclusion process with the excluded task group as the target device.

7. The non-transitory computer-readable storage medium according to claim 6,
wherein the computer-executable instructions are configured to, when executed by the controller, cause the information processing apparatus to perform:
a task deletion process of deleting, from the command group, the task completed by all of the associated target devices,
wherein, in the restoration process, the information processing apparatus generates an additional command group in a case where any task included in the excluded task group has been deleted by the task deletion process, the additional command group including a task which has been deleted by the task deletion process and associated with the specific state device, and
wherein, in the first execution instruction process, the information processing apparatus issues the execution instruction of a task to the target device associated with the task included in the additional command group in response to the additional command group being generated.

8. The non-transitory computer-readable storage medium according to claim 7,
wherein, in the restoration process, the information processing apparatus generates the additional command group including all of the tasks included in the excluded task group in a case where any task included in the excluded task group has been deleted by the task deletion process.

9. The non-transitory computer-readable storage medium according to claim 1,
wherein the specific state device includes a task-rejected device which has rejected at least one of the one or more tasks,
wherein the computer-executable instructions are configured to, when executed by the controller, cause the information processing apparatus to perform:
a notification process of notifying a user of the information processing apparatus that the task-rejected device exists.

10. The non-transitory computer-readable storage medium according to claim 5,
wherein the specific state device includes a task-rejected device which has rejected at least one of the one or more tasks,
wherein the computer-executable instructions are configured to, when executed by the controller, cause the information processing apparatus to perform:
a receiving process of receiving an execution request by a user of the information processing apparatus, and
wherein the second execution instruction process is performed in response to the execution request being received.

11. The non-transitory computer-readable storage medium according to claim 6,
wherein the specific state device includes a task-rejected device which has rejected at least one of the one or more tasks,
wherein the computer-executable instructions are configured to, when executed by the controller, cause the information processing apparatus to perform:
a receiving process of receiving an execution request by a user of the information processing apparatus, and
wherein the restoration process is performed in response to the execution request being received.

12. The non-transitory computer-readable storage medium according to claim 5,
wherein the specific state device includes a task-deferred device which is a device indicating that execution of at least one of the one or more tasks is to be deferred until a particular execution timing, and
wherein the second execution instruction process is performed in response to the particular execution timing having arrived.

13. The non-transitory computer-readable storage medium according to claim 6,
wherein the specific state device includes a task-deferred device which is a device indicating that execution of at least one of the one or more tasks is to be deferred until a particular execution timing, and
wherein the restoration process is performed in response to the particular execution timing having arrived.

14. The non-transitory computer-readable storage medium according to claim 1,
wherein, in the command group, for each task, an instruction order for the target devices associated with the task is specified,
wherein, in the first execution instruction process, the information processing apparatus issues the execution instruction in the instruction order,
wherein the specific state device includes a task-deferred device which is a device indicating that execution of at least one of the one or more tasks is to be deferred until a particular execution timing,
wherein, in the device exclusion process, the task-deferred device is excluded from a target device of the device exclusion process in a case where a remaining time until the particular execution timing is less than or equal to a time threshold,
wherein the computer-executable instructions are configured to, when executed by the controller, cause the information processing apparatus to perform:
a rank adjustment process of lowering a rank of the task-deferred device in the instruction order for each of the excluded task group.

15. An information processing apparatus communicable with multiple devices, the information processing apparatus comprising a controller,
wherein the controller is configured to perform:
an execution instruction process of executing a process subject to a command group including one or more tasks, at least one of the multiple devices being associated with each of the one or more tasks as a target device that the each of the one or more tasks is to be executed, the execution instruction process sequentially issuing an execution instruction of a task to the target device associated with the task in accordance with an particular task order for each of one or more tasks;
an obtaining process of obtaining an execution status of the command group in the multiple devices for the execution instruction process; and
a device exclusion process of excluding a specific state device from an excluded task group based on the obtained execution status in a case where the specific state device exists in the multiple devices, the specific state device being a device in a specific state that cannot complete the command group, the excluded task group including at least one task associated with the specific state device of the one or more tasks.

16. A device management method comprising:
sequentially issuing an execution instruction of a task to a target device associated with the task for each of one or more tasks;
obtaining an execution status of the task corresponding to the execution instruction in the one or more tasks; and
excluding a specific state device from at least one task associated with the specific state device of the one or more tasks based on the obtained execution status in a case where the specific state device exists in the multiple devices, the specific state device being a device in a specific state that cannot complete the task corresponding to the execution instruction.
